(19) United States
(12) Patent Application Publication
(10) Pub. No.: US 2002/0073272 A1
(43) Pub. Date: Jun. 13, 2002

(54) Method of programming a multi-flash memory system

(75) Inventors: Young-Wi Ko, Kyunggi-do (KR); Young-Joon Choi, Kyunggi-do (KR)

Correspondence Address: MARGER JOHNSON & McCOLLOM, P.C., 1030 S.W. Morrison Street, Portland, OR, 97205, US

(73) Assignee: Samsung Electronics Co., Ltd., Suwon City (KR)

(21) Appl. No.: 10/007,083

(22) Filed: Dec. 6, 2001

(30) Foreign Application Priority Data
Dec. 7, 2000 (KR) 2000-74164

(51) Int. Cl. G06F 12/00

(52) U.S. Cl. 711/103

(57) ABSTRACT

A preferred method of programming a multi-flash memory device uses a shared selection signal for the flash memory chips. A first page in a first chip is programmed in a first programming operation. A first page in a second chip is then programmed in a second programming operation. The programmed state of the first chip is checked by inputting a first status command during the second programming operation. A second page in the first chip is programmed in a third programming operation and a programmed state of the second chip can be checked by inputting a second status command during the third programming operation. A second page in the second chip can also be programmed. An improved multi-flash memory system structure is also provided.

This application relies for priority upon Korean Patent Application No. 2000-074164, filed on Dec. 7, 2000, the contents of which are herein incorporated by reference in their entirety.

### BACKGROUND OF THE INVENTION

1. Field of the Invention

The present invention relates generally to non-volatile semiconductor memory devices and more specifically, to a method of programming a multi-flash memory system.

2. Description of Related Art

There is an increasing demand for electrically programmable and erasable nonvolatile semiconductor memories with higher integration of memory cell arrays for storing large amounts of data. Increased programming operation speeds are also desired.

In particular, flash memories used in the digital multi-media field (such as digital still cameras (DSCs) and MP3 music systems) require higher programming operation speeds. In DSCs, as the number of pixels (or resolution) of the digital picture increases, the size of a picture file also increases. A flash memory that is capable of high-speed programming to process and store the increased amount of data corresponding thereto is desired. In MP3 music systems, a high-speed programmable flash memory is required to facilitate the rapid downloads of music files. A program speed in a conventional NAND flash memory is about 2.3 MB (Megabytes) per second on a single chip.

In the conventional programming operation, the method of driving a single flash memory chip is different from that of driving multiple flash memory chips (i.e., a multi-flash memory system). The conventional method of driving a plurality of flash memory chips utilizes a separate chip enable pin/CE to operate each of the respective flash chips. FIG. 1 is a schematic block diagram showing a conventional multi-flash memory system having a dual flash chip card. Referring to FIG. 1, two flash memory chips A, B are provided. Each memory chip A, B includes a pad 6, 7 for receiving a respective one of the chip enable signals/CEA, /CEB, provided from a controller 5.

FIG. 2 is a timing diagram illustrating operating signals of the conventional multi-flash memory system of FIG. 1. Referring to FIGS. 1 and 2, an operation of the multi-flash memory system begins by activating the appropriate flash memory chip A, B in response to its corresponding chip enable signal/CEA, /CEB. The chip enable signals/CEA, /CEB are alternately driven. Regions where internal ready/busy signals IRBA, IRBB of the respective flash memory chips A, B overlap each other are generated in response to an external ready/busy signal XRB to improve the speed of the programming operation.

Unfortunately, the conventional design requires the same number of chip enable pins and chip enable pads as flash memory chips. When a large number of chips are embedded in a single board or a card, therefore, the circuit becomes fairly complex. Due to the complex circuit design, manufacturing costs, as well as the cost of operating the controller, are increased.

### SUMMARY OF THE INVENTION

Preferred embodiments of the present invention provide inexpensive improvement in the speed and performance of a program operation in a memory system employing multiple flash memory chips.

More particularly, a preferred method of programming a device having multiple flash memory chips uses a shared selection signal to select the flash memory chips. In the preferred method, a first page in a first chip is programmed, followed by a first page in a second chip. The programmed state of the first chip can be checked by inputting a first status command during the programming operation for the second chip. A second page in the first chip is then programmed. A programmed state of the second chip is checked by inputting a second status command during the programming operation for the first chip. A second page in the second chip can also be programmed.

### BRIEF DESCRIPTION OF THE DRAWINGS

The foregoing and other objects, features, and advantages of the present invention will become more readily apparent through the following detailed description of preferred embodiments, made with reference to the accompanying drawings, in which like reference symbols indicate the same or similar components, and wherein:

FIG. 1 is a schematic block diagram illustrating a conventional multi-flash memory system;

FIG. 2 is a timing diagram showing signals during a programming operation of the multi-flash memory system of FIG. 1;

FIG. 3 is a schematic block diagram illustrating a multi-flash memory system according to a preferred embodiment of the present invention;

FIG. 4 is a timing diagram showing signals during a programming operation of the multi-flash memory system of FIG. 3;

FIGS. 5A and 5B are flow charts representing a programming method according to a preferred embodiment of the present invention.

### DESCRIPTION OF PREFERRED EMBODIMENTS

The following detailed description of preferred embodiments is illustrative only. The invention is not limited to these preferred embodiments. Also, although descriptions of certain well-known systems, operations, and/or components will be provided herein to facilitate a better understanding of the invention, the descriptions of other well-known systems, operations, or components may be omitted.

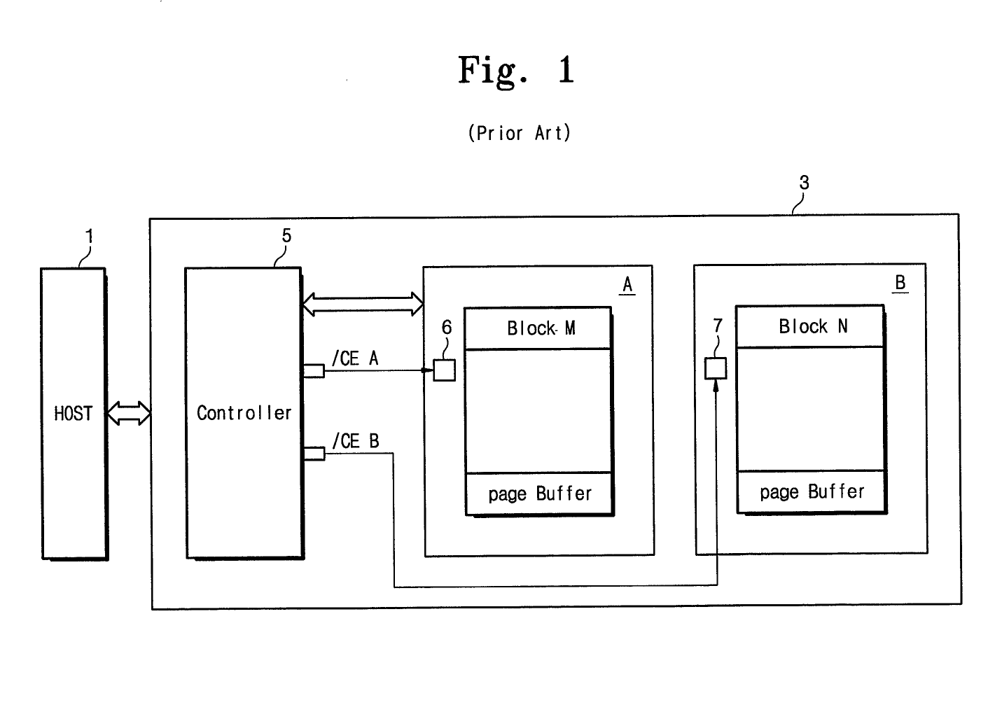

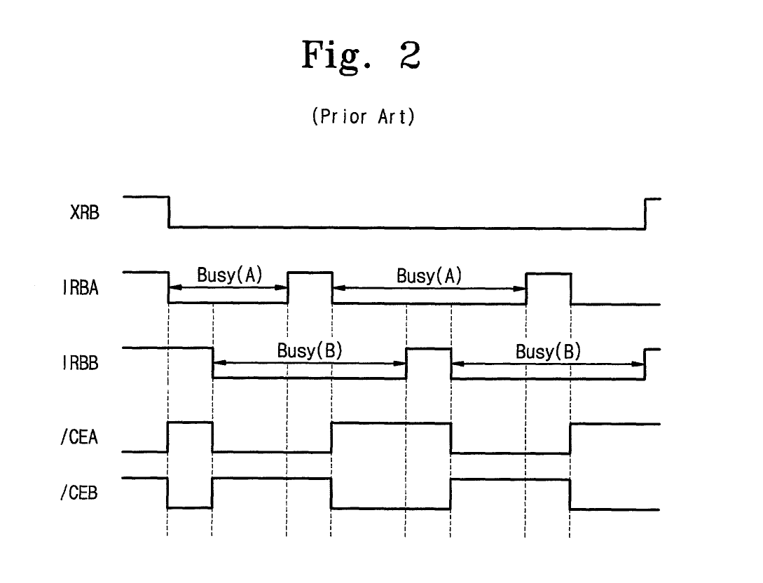

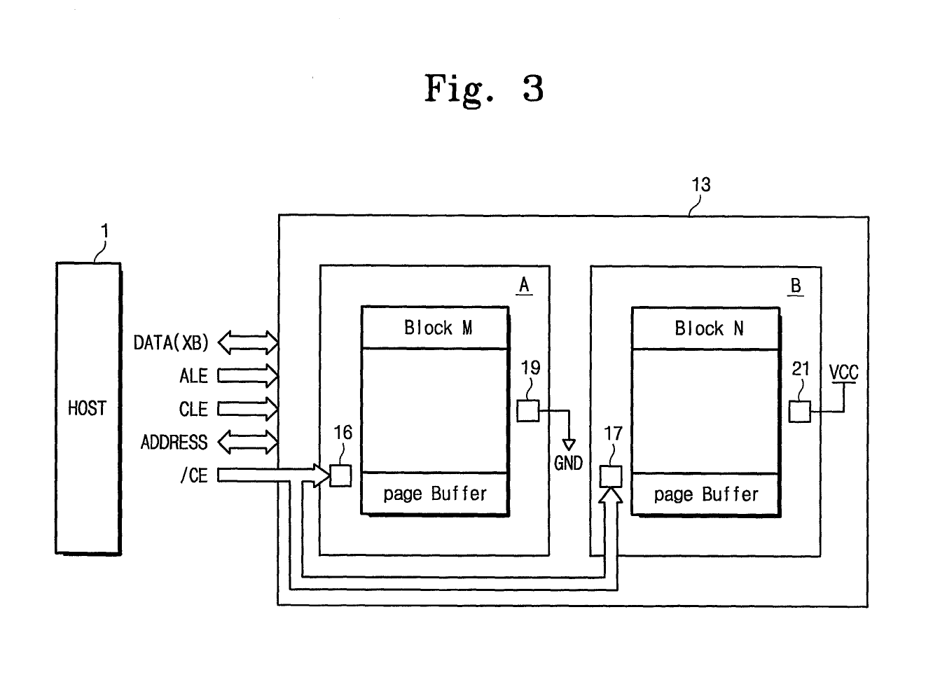

FIG. 3 is a schematic block diagram showing a multi-flash memory system 13 according to a preferred embodiment of the present invention. The multi-flash memory system 13 can directly interface with a host (i.e., a host processor or controller) 1. The system 13 is supplied with an address latch enable signal ALE, a command latch enable signal CLE, an address signal ADDRESS, and a chip enable signal (or chip selection signal)/CE from the host 1. The chip enable signal/CE is applied to respective input pads 16, 17 of each of the flash chips A, B, thereby providing a shared chip selection signal. Accordingly, unlike the conventional system of FIG. 1, this embodiment does not require multiple chip enable signals.

Because the chip enable signal/CE is synchronously applied to both of the flash memory chips A, B, bonding pads embedded in the chips A, B are used to select a desired one of the chips. In this embodiment, a pad 19, embedded in a first chip A, is connected to ground voltage GND. A pad 21, embedded in a second chip B, is connected to power supply voltage VCC. Therefore, if a most significant bit MSB of the address signal ADDRESS is “0”, the first chip A is selected. If, however, the most significant bit MSB of the address signal ADDRESS is “1”, the second chip B is selected. By extension of the principles taught herein, this system can also be used for multi-flash memory systems employing more than two chips. Before the multi-chip programming mode (“multi-mode” or “dual-mode”) is explained in detail, the well-known single-chip programming mode (single-mode) will be briefly explained. In single-mode programming, only the first chip A or the second chip B operates. Assuming that the first chip A is operated in the single-mode, a block or a page to be programmed is selected in the first chip A after receiving a program set up command. Thereafter, data is loaded into and stored in a corresponding page buffer. The selected block or page of the first chip A is then programmed in response to a program command.

An external ready/busy pin indicates whether or not the programming operation is being performed. During the programming operation, the ready/busy pin is in a low (busy) state. When the programming operation is over, the ready/busy pin goes to high (ready) state. When the ready/busy pin is in the low state, a status command is provided to check whether the program operation has passed (PASS) or failed (FAIL) through an input/output pin. If the status of the programming operation is PASS, the ready/busy pin goes to a high state. The programming operation for the second chip B is the same as that of chip A.

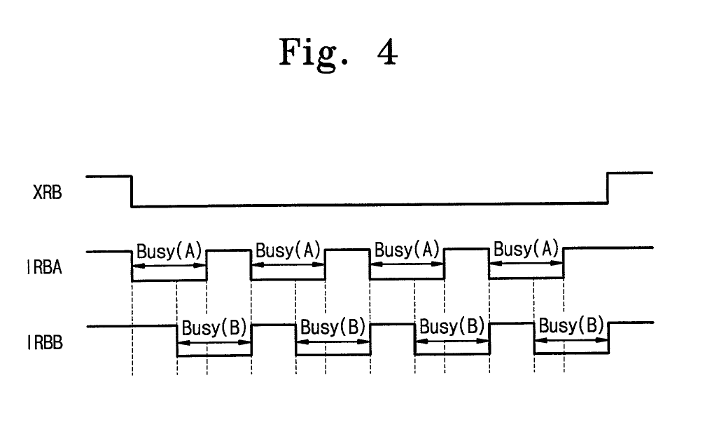

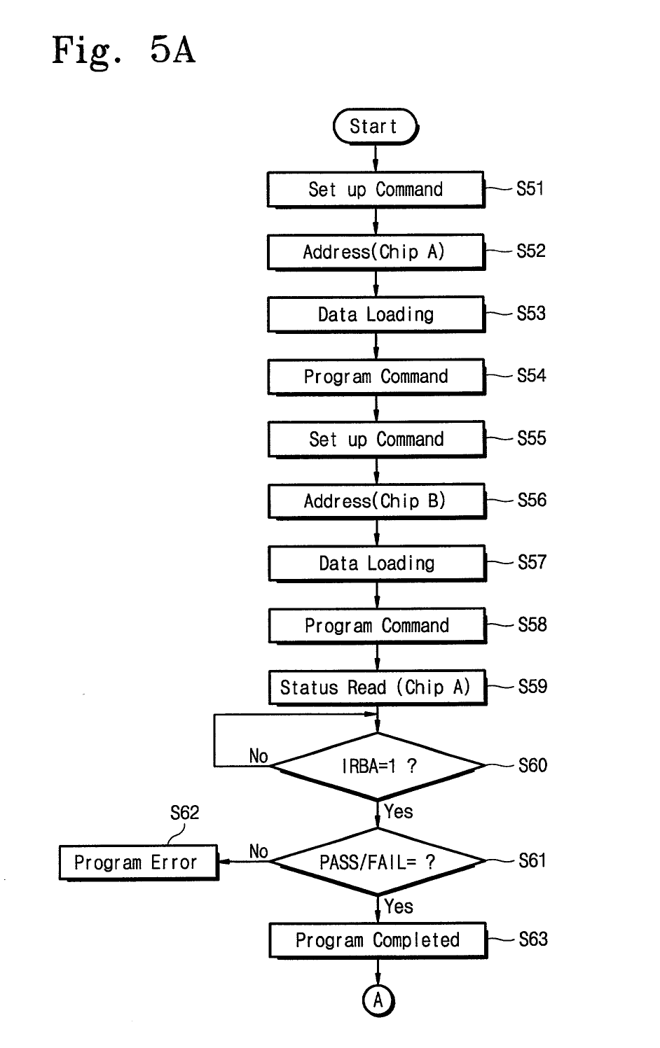

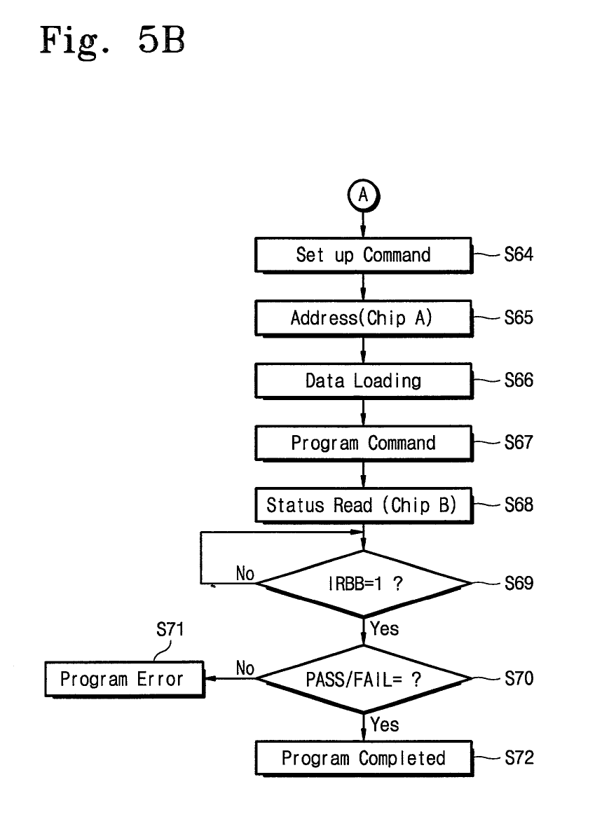

A method of programming a multi-flash memory system, according to another aspect of the present invention, will now be explained with reference to FIGS. 4 and 5. In the preferred multi- or dual-mode, an external ready/busy pin XRB remains in a low state to receive commands. The programming operation is concurrently performed for two chips A, B. Because the chip enable signal/CE is commonly connected to these chips A, B, they are each in an activated state. In this state, if the MSB of the address signal ADDRESS is “0”, an address decoding operation is performed for the first chip A. A respective one of the internal ready/busy pins IRBA, IRBB is retained in a low (busy) state while a corresponding chip A, B is being programmed.

Referring to FIG. 5A, in this embodiment, a first chip A is programmed first (although either chip A, B could be programmed first). To program the first chip A, a set-up command is inputted (step S51). An address is then provided to select a page of the first chip A (step S52), and data to be programmed is stored in a corresponding page buffer (step S53). Thereafter, the selected page in the first chip A is programmed in response to a program execution command (step S54).

The foregoing process is then repeated for a first page in the second chip B. Specifically, a program set-up command (step S55) initiates the programming operation in the second chip B. An address input is used to select a page of the second chip B to be programmed (step S56), and data is loaded into a page buffer (step S57). The selected page in the second chip B is then programmed in response to a program execution command (step S58). During the programming period, the external ready/busy pin XRB remains in a low state, corresponding to a busy state of the internal ready/busy pins IRBA, IRBB of the chips A, B.

When the status command is input (step S59), a programmed state of the first chip A is checked. The method determines whether the program operation for the chip A is completed or not by checking the status of the internal ready/busy pin IRBA (or another predetermined input/output pin) (step S60). If the ready/busy pin IRBA is at a low level, indicating that the program operation is still in progress, the status of the pin IRBA is reiteratively checked (repeat step S60) until the program operation is confirmed to be over. A high level on the pin IRBA indicates that the program operation for the first chip A is over, and the method proceeds to verify the PASS/FAIL status of the program operation (step S61).

A read enable signal/RE controls the PASS/FAIL status check (step 61). The PASS/FAIL status of the program operation can be verified through a predetermined input/output pin. If the program operation fails (i.e., FAIL status), a program error step (step S62) is performed. If the program operation passes (i.e., PASS status), the program operation for the selected page in the first chip A is treated as completed (step S63).

Using the foregoing process, program operations for a first page in the first chip A and a first page in the second chip B are performed. A program operation for a newly selected (second) page in the first chip A proceeds as shown in FIG. 5B. Referring now to FIG. 5B, the program operation for the second page proceeds similar to that of the first page. A program set-up command is issued (S64) and an address input is used to select the second page (S65). The data is loaded into a page buffer (S66) and the selected page is programmed in response to a program execution command (S67).

The program verification operation for verifying the programmed status of the second chip B is preferably performed while programming the second page in the first chip A. The process is similar to that of verifying the program status of the first chip A. Specifically, a status command is input (step S68) to check the programmed state of the second chip B. The status of the internal ready/busy pin IRBB (or another predetermined input/output pin) is checked (step S69) to determine the program status. If the ready/busy pin IRBB is at a low (busy) level, the program operation is still in progress, and the status of the pin IRBA is reiteratively checked (repeat step S69) until the program operation is confirmed to be over. A high level on the pin IRBB indicates that the program operation for the second chip B is over, and the method proceeds to verify the PASS/FAIL status of the program operation (step S70).

A read enable signal/RE controls a PASS/FAIL status check (step 70). The PASS/FAIL status of the program operation can be verified through a predetermined input/output pin. If the program operation fails (i.e., FAIL status), a program error step (step S71) is performed. If the program operation passes (i.e., PASS status), the program operation for the selected page in the second chip B is treated as completed (step S72). Although not shown in FIG. 5B, after program completion, a newly selected (second) page of the second chip B can be programmed in a manner similar to that describe above with respect to the second page in the first chip A.

The programming process is preferably arranged in process segments that can be reiteratively performed. For instance, the first chip A can be programmed during a first process segment (S51˜S54). During a second process segment, the second chip B can be programmed (S55˜S58). A third process segment can include checking the program status of the first chip A (S59˜S63) and programming a second page in the first chip A (S64˜S67) can be done during a fourth process segment. The program status of the second chip B (S68˜S72) can be checked during a fifth process segment. A second page in the second chip B can then be programmed during a sixth process segment.

Preferably, while one of the chips (A or B) is being programmed, the programmed state or result of the other chip (B or A) is being checked. The status command can have different signal patterns for the respective chips A, B. Further, once the status command for checking the program state/result is inputted to a corresponding chip, it is preferably latched within the chip. A signal representing the program state/result is therefore provided externally through an input/output pin in response to a toggling of the read enable signal.

Although the foregoing description explains a synchronous program operation for two flash memory chips, the foregoing operation could be used in a card or system having any number of flash memory chips. As described above, therefore, various embodiments of the present invention provide a synchronous program operation in a multi-flash memory system that operates by sharing a chip enable signal. The speed of the program operation is thereby increased. Furthermore, although the invention has been shown and described with reference to preferred embodiments thereof, it will be understood by those skilled in the art that various changes in the form and details thereof may be made without departing from the spirit and scope of the invention as defined by the appended claims.

What is claimed is:

1. A method of programming a device having a plurality of flash memory chips, the method comprising:
programming a first page in a first chip;
programming a first page in a second chip;
checking a programmed state of the first chip by inputting a first status command while programming the second chip;
programming a second page in the first chip; and checking a programmed state of the second chip by inputting a second status command while programming the first chip.

2. A method according to claim 1, wherein selection signals for the flash memory chips are shared.

3. A method according to claim 1, further comprising programming a second page in the second chip.

4. A method according to claim 1, further comprising repeatedly checking the programmed state of the first chip until the programming operation of the first chip is confirmed to be over.

5. A method according to claim 1, further comprising repeatedly checking the programmed state of the second chip until the programming operation of the second chip is confirmed to be over.

6. A method according to claim 1, further comprising verifying a PASS/FAIL status of the programming operation of the first chip.

7. A method according to claim 1, further comprising verifying a PASS/FAIL status of the programming operation of the second chip.

8. A method according to claim 1, wherein the programming operation of the first chip comprises inputting a set-up command, providing an address to select a page of the first chip, storing data to be programmed in a page buffer, and programming the selected page in the first chip in response to a program execution command.

9. A method according to claim 1, wherein the programming operation of the second chip comprises inputting a set-up command, providing an address to select a page of the second chip, storing data to be programmed in a page buffer, and programming the selected page in the second chip in response to a program execution command.

10. A multi-flash memory system comprising:
a host interface configured to receive an address latch enable signal, a command latch enable signal, an address signal, and a chip enable signal;
a plurality of flash memory chips, each chip comprising a pad; and
wherein the pads of each of the memory chips are configured to commonly receive the chip enable signal.

11. A multi-flash memory system according to claim 10, further comprising:
a pad in a first chip electrically connected to a ground voltage; and
a pad in a second chip electrically connected to a power supply voltage.

12. A multi-flash memory system according to claim 11, wherein a most significant bit of the address signal is used to select one of the flash memory chips.

13. A multi-flash memory system according to claim 12, wherein if the most significant bit of the address signal is “0”, the first chip is selected; and wherein if the most significant bit of the address signal is “1”, the second chip is selected.

14. A multi-flash memory system according to claim 10, wherein:
a first page in the first chip is configured to be programmed during a first programming operation;
a first page in the second chip is configured to be programmed during a second programming operation;
a ready/busy pin of the first chip is configured to indicate a programmed state of the first chip in response to a first status command during the second programming operation;
a second page in the first chip is configured to be programmed during a third programming operation; and
a ready/busy pin of the second chip is configured to indicate a programmed state of the second chip in response to a second status command during the third programming operation.

15. A method of programming a multi-flash memory system, said method comprising:
using a shared selection signal to select a flash memory chip for an operation;
selecting and programming a first page in a first chip in a first programming operation;
selecting and programming a first page in a second chip during a second programming operation; and
verifying a program status of the first chip during the second programming operation.

16. A method according to claim 15, further comprising:
selecting and programming a second page in the first chip during a third programming operation; and
verifying a program status of the second chip during the third programming operation.

17. A method according to claim 16, further comprising selecting and programming a second page in the second chip during a fourth programming operation.

18. A method according to claim 15, wherein verifying the program status of the first chip comprises inputting a status command and checking the status of a ready/busy pin of the first chip.

19. A method according to claim 16, wherein verifying the program status of the second chip comprises inputting a status command and checking the status of a ready/busy pin of the second chip.

20. A method according to claim 15, further comprising performing PASS/FAIL status checks on the first and second chips using a read enable signal.
